(19) United States
(12) Patent Application Publication
(10) Pub. No.: US 2002/0184057 A1
(43) Pub. Date: Dec. 5, 2002

(54) System, apparatus, and method for providing insurance design service

(75) Inventors: Soichi Hayashi, Chiba (JP); Shin Sasaki, Kanagawa (JP); Noriko Yoshino, Tokyo (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: SONY CORPORATION, Shinagawa-Ku (JP)

(21) Appl. No.: 09/867,459

(22) Filed: May 31, 2001

(51) Int. Cl. G06F 17/60

(52) U.S. Cl. 705/4

(57) ABSTRACT

Free design service system, apparatus, and method of life insurance enabling salespersons and customers to design life insurance that meets one's specific requirements easily from terminal equipment. This system allows anyone to access via network a life insurance design home page on a Web server from one's device such as a personal computer and set the data including the classification of insurance to be reviewed, type, term insured, and age and gender of insured from information available on a design input screen. Accordingly, an insurance premium calculation module provided by the web server calculates a premium, a handling regulations module detects the prescribed consistency of the settings, and a various cumulative calculation module adds up various cumulative amounts. The surrender value is also calculated by a surrender value calculation module. All these data are available in a table format or graphically displayed by a graph drawing module.

### BACKGROUND OF THE INVENTION

1. Field of the Invention

This invention relates to a system, apparatus, and method for providing via network an insurance design service, and, more particularly to, an insurance design service of furnishing information about prescribed insurance to each individual, for example, introduction of a life insurance product specifically tailor-made thereto.

2. Description of the Related Art

Recent years have seen the widespread use of extensive, large-scale communication networks represented by the Internet. Moreover, this kind of communication network is used not only for an E-mail (Electronic-mail) and data transfer but also for providing various information and transactions of products. It is in this environment that automobile insurance, for instance, has already come to a stage wherein providing individual information and an application for a contract can be rendered via the Internet.

Nonetheless, in insurance such as life insurance, there has not hitherto been offered any service via network which offers detailed explanation about a specific case relating to each user, for example, the kind of service that provides information to each person, with enough details to design a tailor-made life insurance to meet the specific requirements thereof.

Reasons for the lack of this service will be described below by taking life insurance as an example. But, first, take automobile insurance for comparison. In automobile insurance, when relatively simple data such as the items to be listed in the Automobile Inspection Certificate, information on the user and the contents of a desired guarantee are established, information such as insurance premium can be calculated, whereas, in a case of life insurance, conditions to calculate the provided information as well as their processing are extremely complex, so that this complexity is one good reason for making it impossible to realize the service with a simple system. As compared with ordinary non-life insurance, life insurance covers a wide range of items with respect to the contents of the guarantee and reasons for payment.

Further, insurance that belongs to the category of life insurance is available in 20 to 30 kinds, and some insurance can be combined therewith while other insurance cannot, thus making design work very difficult.

Still further, in many cases, life insurance is subject to a long term such as 30 years or for entire life. In addition, since it has an asset value, information on surrender time and the concomitant surrender value become critical data. It should be pointed out that mere calculation of the surrender value involves extremely complex processing. Highly specialized information such as information on the policy holder's health including clinical history and the settings of the insurance rates based on the clinical history must also be taken into account. For these reasons, in most cases, detailed explanation of life insurance has conventionally been made available through direct means, namely by salespersons (including the staff of agents engaged in soliciting applications for insurance). There has been no case of providing detailed information via network.

Under these disadvantageous circumstance in which, if the user wants to obtain explanation on life insurance, there is no alternative but to meet directly with the salesperson from an insurance company, whence the user has to undergo a cumbersome procedure of taking time out to have a meeting, to speak nothing of entertaining apprehensions about a possible persistent sales approach that is most likely to befall on the user later, thus often giving rise to a hesitation about directly obtaining the explanation from the salesperson. Conversely, from the standpoint of the insurance company, this means an unconditional loss of sales opportunity which calls for an improvement. That is, both the user and the insurance company have long harbored a request for lighthearted, simpler procedures whereby the explanation is offered and received.

On the other hand, when the salesperson gives a direct explanation to the user, as previously described, the conditions and the product contents being complex and multifarious, this type of insurance has a difficulty that renders it hardly possible to design the product in keeping with the user's specific conditions in front of the user, calculating an accurate premium, the contents of the guarantee available and other details, showing the insurance product best suited thereto, and explaining various features thereof. Consequently, quite often, the salesperson, when introducing insurance products, resorts to the practice of selecting out of a number of pre-arranged model cases the one that closely meets the user's conditions and explaining the available products with reference thereto.

Another conventional sales method in use is by means of a portable personal computer or any other similar device which the salesperson carries with oneself to a meeting with the user to provide explanation, inputs the conditions of the user and other data into the computer in the presence thereof, so that the salesperson can immediately present the insurance product designed according to the conditions thereof. This type of sales support system is currently being used.

Nevertheless, a major disadvantage of the sales support system mentioned above is the inherent complexity of its own, since sales support software capable of designing an insurance product based on inputted conditions and presenting the recommendations must be developed and installed in each personal computer for the salesperson, with further tasks of system maintenance such as creating newer versions of the software and updating data. This also means that the salesperson is unable to carry out a proper introduction of the product suitable for the user without using the sales support system based on the exclusive hardware of this type, thereby causing a new burden upon the salesperson.

### SUMMARY OF THE INVENTION

Accordingly, it is an object of this invention to provide a system, apparatus, and method for presenting an insurance design service wherein acquisition of various information about insurance, e.g., life insurance, to meet the specific need of each individual, is facilitated. Namely, insofar as the general user is concerned, this invention purports to offer the system, apparatus, and method which enable the general user to obtain easily the kind of information that meets the specific conditions thereof, at any time, by means of simple processing-without directly meeting with the salesperson, whilst, in terms of the salesperson, the system, apparatus, and method of this invention purport to enable the salesperson to obtain easily the kind of information that meets the specific conditions of the individual user, at any time, at any place, with no recourse to exclusive hardware, and with simple maintenance.

To address the deficiencies of the existing procedures enumerated above, an insurance design service providing system according to this invention includes any arbitrary communication network, a plurality of nodes connected to the communication network, and a server device which, when prescribed conditions regarding the design of prescribed insurance are inputted into any of the nodes connected to the communication network, generates information regarding an insurance product that meets the conditions and transmits the generated information to the node into which the prescribed information was inputted.

Ideally speaking, the server device transmits, as necessary, a processing module, which executes processing to generate the information, to the aforementioned node device, generating and transmitting the information to the node by virtue of executing the processing module on the node device. Specifically, the server device performs, with respect to the insurance product based on the inputted conditions described above, one, a plurality of, or all of the processing of examining whether the insurance product meets the prescribed regulations, calculating the premium, extracting the contents of the guarantee, calculating the surrender value, detecting information regarding accounting processing, and making a comparison to other insurance products, then generates information on the results of the processing, and transmits the information to the node.

Also, specifically, the server device transmits, as necessary, a graph drawing module for displaying graphically information on the result of each of the processes to the node, so that the information on the results of the processing is graphically displayed by executing the graph drawing module on the node.

To be specific, the insurance mentioned above is life insurance, any of the plurality of nodes inputting the prescribed conditions relating to the design of life insurance into the server device, the server device generating the information regarding the life insurance product that meets the inputted conditions and transmitting the information to the node.

To be more specific, the prescribed conditions relating to the design of the life insurance are those conditions including one, a plurality of, or all of the conditions regarding the age of the policy holder, the gender thereof, the family composition thereof, the clinical history thereof, the classification of insurance, the type of insurance, the payment method of premium, the term insured, the period of payment of premium, and the contents of the guarantee including the amount insured.

Moreover, an insurance design service providing apparatus according to this invention is a server device connected to any arbitrary communication network to which a plurality of nodes are connected, having a receiving means for receiving the prescribed conditions relating to the design of prescribed insurance from any of the nodes connected to the communication network, an information generation means for generating information regarding the insurance product that meets the conditions received, and a transmission means for transmitting the information generated to the node into which the prescribed information was inputted.

Ideally speaking, the transmission means transmits a processing module relating beforehand to the design of insurance, which is also a processing module for generating the information on insurance specification based on the information generated by the information generation means, to the preceding node into which the prescribed information was inputted, thereby generating the information on insurance specification on the node; further ideally, the apparatus according to this invention includes a database means for storing the prescribed conditions relating to the design of prescribed insurance inputted from the node.

Specifically, the preceding insurance is life insurance, and the receiving means receives the prescribed conditions relating to the design of life insurance from the node, while the information generation means generates information regarding the life insurance product meeting the conditions received.

Moreover, in an insurance design service providing method according to this invention, there is provided a server device generating, based on the prescribed conditions relating to the design of prescribed insurance to be inputted, information regarding the insurance product meeting the conditions, the server device being connected as a Web site to the communication network to which a plurality of nodes are connected, so that when access is gained from any of the nodes to the Web site, an input processing module for inputting the preceding conditions to the node mentioned above is transmitted, and that when the conditions are inputted via the input processing module, desired information regarding the life insurance product meeting the conditions is generated, whereupon the information thus generated is outputted from the node to which the conditions were inputted.

### BRIEF DESCRIPTION OF THE DRAWINGS

The foregoing and other objects and features of this invention will become more apparent upon a consideration of the following description taken in connection with the accompanying drawings wherein:

FIG. 1 is a diagram explaining a structure and operating environment of a free design service system of life insurance according to a preferred embodiment of this invention;

FIG. 2 is a block diagram showing the structure of a web server of the free design service system of life insurance illustrated in FIG. 1;

FIG. 3 is a diagram showing a flow of a series of processing to be carried out by the user to design life insurance oneself and obtain information on life insurance by using the free design service system of life insurance;

FIG. 4 is a diagram depicting a design input display screen on a user client apparatus of the free design service system of life insurance shown in FIG. 1;

FIG. 5 is a diagram presenting a screen displaying the contents of a contract in the user client apparatus of the free design service system of life insurance shown in FIG. 1;

FIG. 6 is a diagram illustrating the screen graphically displaying a guarantee in the user client apparatus of the free design service system of life insurance shown in FIG. 1;

FIG. 7 is a diagram showing the screen displaying the contents of the guarantee in the user client apparatus of the free design service system of life insurance depicted in FIG. 1;

FIG. 8 is a diagram showing a term insurance display screen on the user client apparatus of the free design service system of life insurance illustrated in FIG. 1; and

FIG. 9 is a diagram explaining a modification of the free design service system of life insurance shown in FIG. 1.

### DETAILED DESCRIPTION OF THE PREFERRED EMBODIMENT

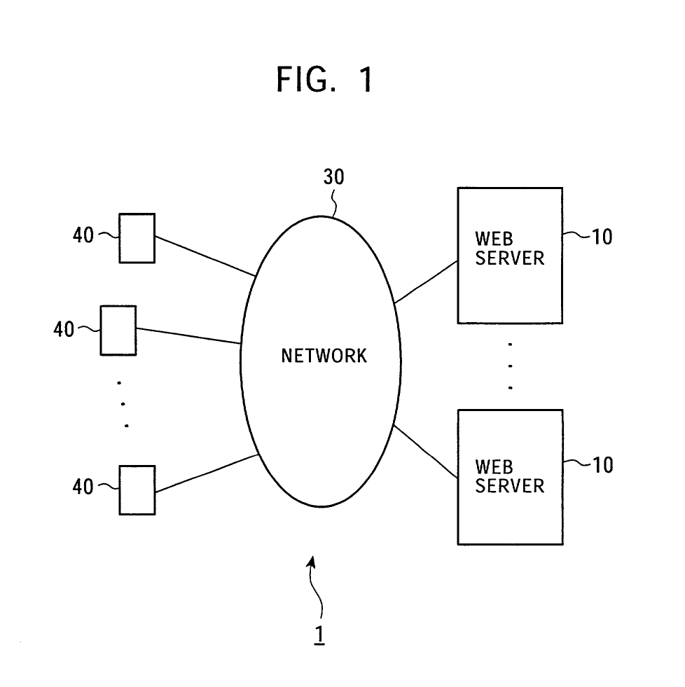

Referring to FIG. 1 through FIG. 8, this invention will be described hereinbelow with respect to a preferred embodiment.

FIG. 1 is a diagram explaining the structure and operating environment of a free design service system of life insurance 1 according to a preferred embodiment of this invention. As shown in FIG. 1, the free design service system of life insurance 1 is constituted by a web server 10 and an arbitrary user client apparatus 40 which is connected to a network 30.

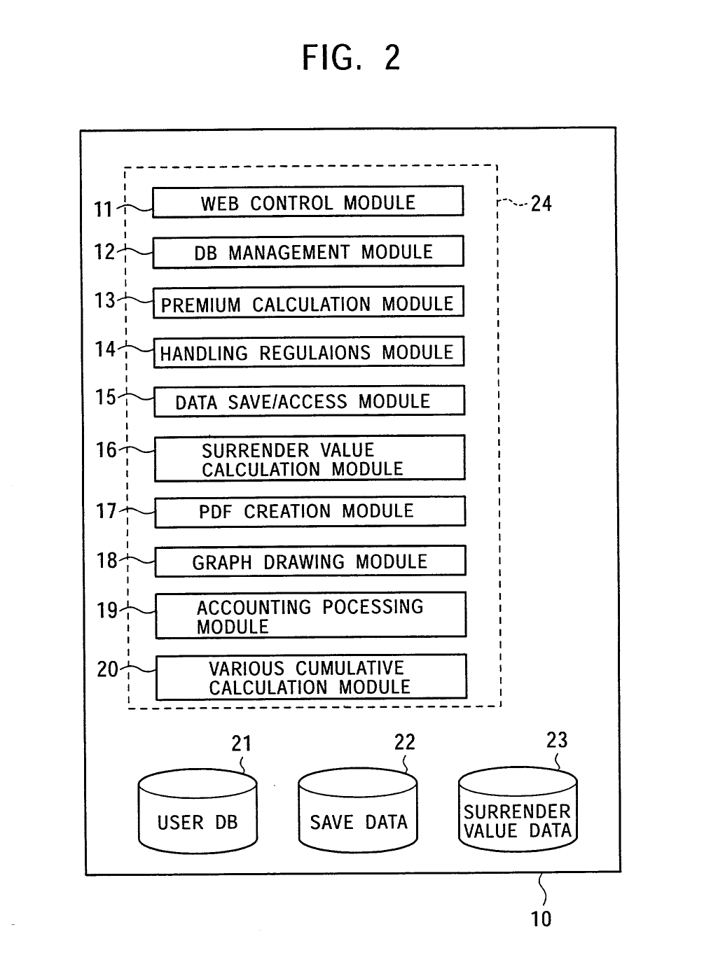

First, construction of each unit will be described. The web server 10 establishes a home page on the network 30 and provides a free design service of life insurance to any user client apparatus 40 accessing via the network 30. The web server 10 as described in FIG. 2 has various processing modules such as a web control module 11, a database control module 12, a premium calculation module 13, a handling regulations module 14, a data save/access module 15, a surrender value calculation module 16, a PDF (Portable Document Format) creation module 17, a graph drawing module 18, an accounting processing module 19, and a various cumulative calculation module 20. In addition, for storage or reference data, a user database 21, a save database 22, and a surrender value database 23 are included therein.

The web control module 11 sets up the home page offering the free design service of life insurance and performs a variety of processes beginning with communications to each user client apparatus 40 so that the free design service of life insurance may be properly rendered to respective access from the user client apparatus 40 via the network 30. For example, the web control module 11 performs processes such as authentication processing with the user client apparatus 40 accompanying the commencement of the service, activating a desired processing module, transmitting the desired processing module to the user client apparatus 40, and a concomitant process of updating the home page screen.

The database control module 12 performs accessing the user database 21 and the save database 22 for updating and reading out the data.

The premium calculation module 13 is a processing module which is to be downloaded to the user client apparatus 30 and executed thereon for providing the input screen to the user, whereby inputs of various insurance-related conditions and settings are accepted, and a premium is calculated based on the inputted conditions and displayed.

The handling regulations module 14 examines whether a life insurance setting established on the input screen of the premium calculation module 13 is a proper setting in terms of law or regulations, and, if not, notifies the premium calculation module that the setting is not established. This handling regulations module 14 is also a processing module to be downloaded to the user client apparatus 30 and executed thereon.

The data save/access module 15 is downloaded to the user client apparatus 30 and executed, communicating to the database control module 12 of the web server 10 to save and read out data with respect to the save database 22.

The surrender value calculation module 16 calculates the surrender value based on the set life insurance conditions with reference to the surrender value database 23. Since this processing involves a complicated process referring to the surrender value database 23 which is a huge table, the surrender value calculation module 16 is executed on the web server 10.

The PDF creation module 17 outputs the design contents when the design of life insurance is completed as a PDF (Portable Document Format) file of the voucher type, contents of which can be guaranteed.

The graph drawing module 18 converts various data regarding the set life insurance, e.g., data including the cumulative total amount of the premium paid, surrender value, and transition of the premium and the necessary amount of guarantee, into graphs which are graphically displayed or printed out.

The accounting processing module 19 takes effect when insurance is under contract with a body corporate, extracting and displaying the premium, the amount insured, or the accounting procedures of the surrender value, information on concomitant taxes, and other data.

The various cumulative calculation module 20 calculates cumulative values based on the conditions of set life insurance, e.g., those of premium paid as well as dividend. In the preferred embodiment of this invention, these processing modules 11 to 20 are described in a Java applet and recorded as the class files.

The user database 21 is a database wherein the users of the free design service system of life insurance 1 are registered, authentication data such as ID (Identification) and password are stored per user therein. When a new user employs the free design service system of life insurance 1, the data thereof are newly registered. Also, when the registered user utilizes this system, the procedures of specifying and authenticating the user makes it possible for the previous save data on the user already stored in the save database to be read out and used.

The save database 22 is a database wherein the result of usage by each user of the free design service system of life insurance 1, i.e., information on the life insurance designed, is stored.

The surrender value database 23 is a database wherein the data on the surrender value per insurance and per condition are stored, and to which the surrender value calculation module 16 refers when calculating the surrender value.

The network 30 is an arbitrary communication network which is the Internet in the preferred embodiment of this invention.

The user client apparatus 40 has a web browsing function as well as a function to execute any downloaded processing module, for example, any node device comprising a personal computer or any other similar device. Through this user client apparatus 40, the user may access the web server via the network 30 and acquire a desired service.

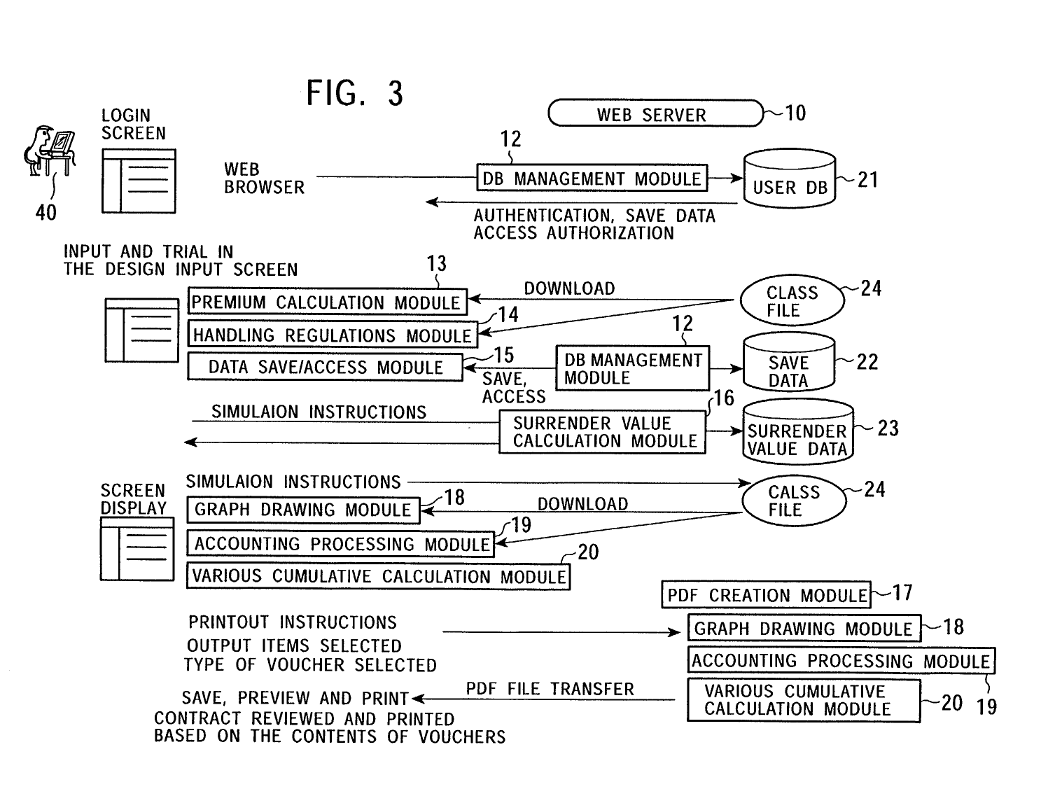

Turning now to FIG. 3 through FIG. 8, the processing flow of the free design service system of life insurance 1 will be described.

FIG. 3 is a chart showing a flow of processing performed by the general user to design one's own life insurance and obtain information on life insurance by using the free design service system of life insurance 1. First, the user or a customer who is conducting a design of the tailor-made life insurance and desiring to obtain information on life insurance logs into the home page offered by the web server 10 via the network 30 from the user client apparatus 40 such as a personal computer. At this instant, the user accessing the web server 10 for the first time registers the user ID and his/her password, while the user with an experience of using the free design service of life insurance inputs the already registered ID and the password.

The web control module 11 of the web server 10 logged in from the user client apparatus 40 activates the database control module 12 and accepts the ID and the password inputted by the user, and, insofar as the user who is already registered is concerned, that user's authentication is processed based on the password, whence, if the authentication is properly conducted, access authorization is granted with respect to the previous save data. In the case of a new user, after subjecting the user to prescribed checkup, the user ID and the password are stored in the user database 21.

After processing the confirmation of the user status in the manner described above, the web control module 11 transmits the premium calculation module 13, the handling regulations module 14, and the data save/access module 15 to the user client apparatus 40, wherein these processing modules are executed as necessary.

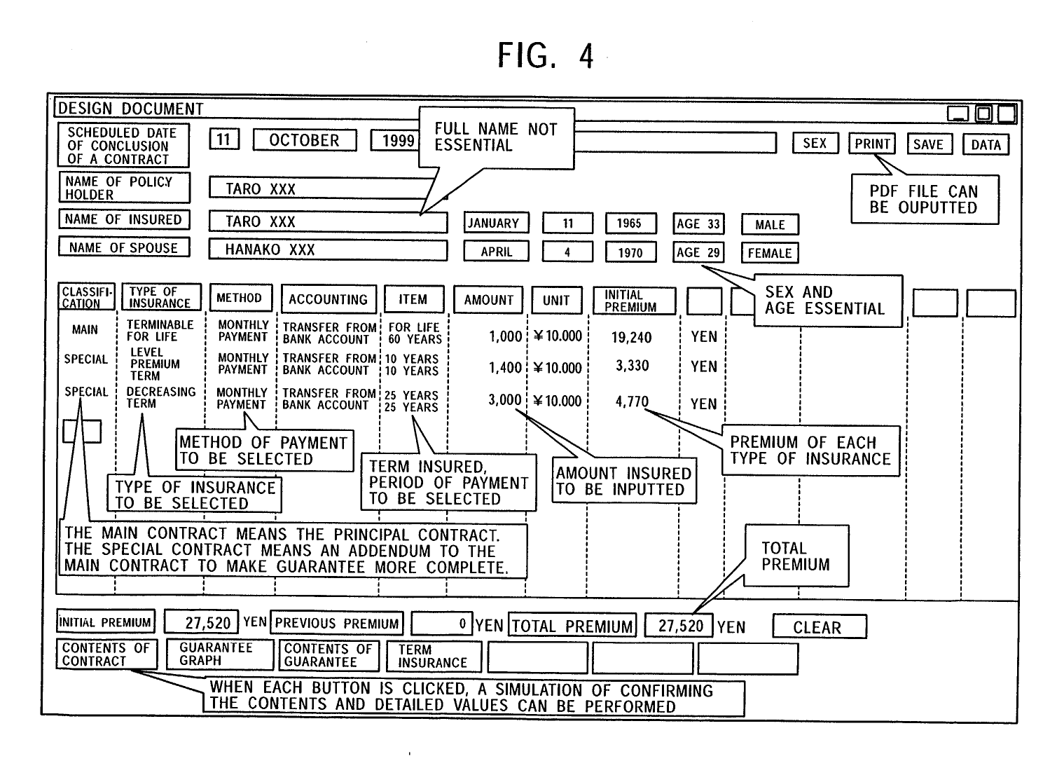

Specifically, the premium calculation module 13 is executed at first, resulting in a display of design input on a screen as shown in FIG. 4, the design input on the screen comprising as depicted the input items of the name of the policyholder, the name of the insured, the name of the spouse, and the dates of birth and the gender of the insured and the spouse at the top section, while at the middle section thereof there is shown a table to be filled in the settings of each insurance with the classification of insurance (a main contract or a special contract), the type of insurance, the payment method (monthly payment, annual payment, payment in lump sum or any other payment), the term insured and the period of payment, the amount insured, and other data.

Now, the user inputs each item on this design input screen and sets up the desired insurance in sequence. If the user has saved the previous design data, the data save/access module 15 functions to access the save database 22 via the database control module 12 of the web server 10 and reads out the save data to be displayed on the design input screen, so that all the user has to do is to modify the data. Once the necessary items are set, the premium calculation module 13 immediately calculates the premium and displays the premium in the same table, further indicating the initial premium and the total amount of premium at the bottom section. Moreover, the handling regulations module 14 functions to examine whether the proposed setting may be permitted in terms of regulations, and if not, reveals on display that the particular setting may not be implemented, concurrently invoking a preventive procedure thereof.

At the top and bottom sections of the design input screen in FIG. 4, there are provided various functional buttons such as a [PRINT] button to output the PDF of the design contents, a [CONTRACT CONTENTS] button to confirm the details of the contents of the contract, and a [GUARANTEE GRAPH] button to indicate the contents of the guarantee graphically, thereby enabling the user, upon completion of the setting procedure, to gain various types of information by selecting any of these buttons as necessary.

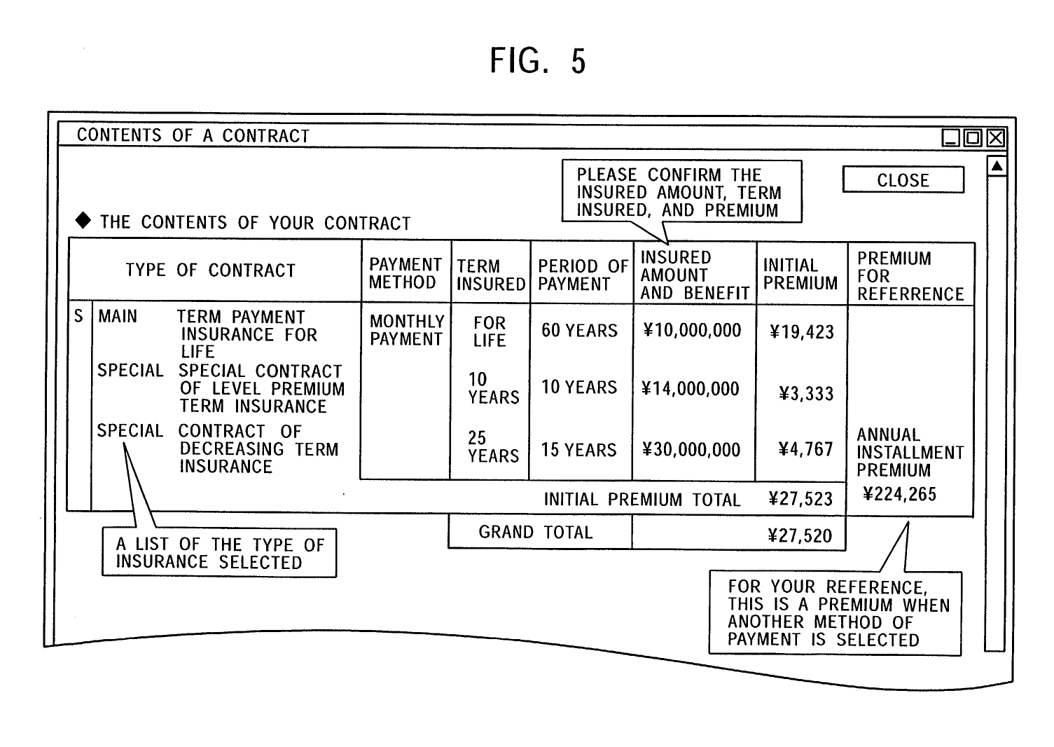

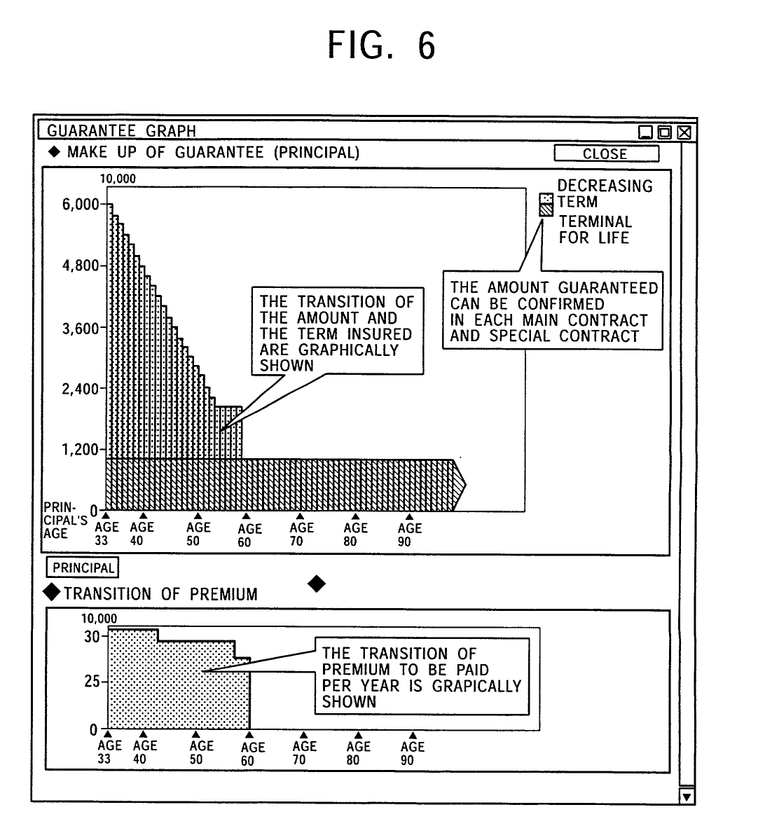

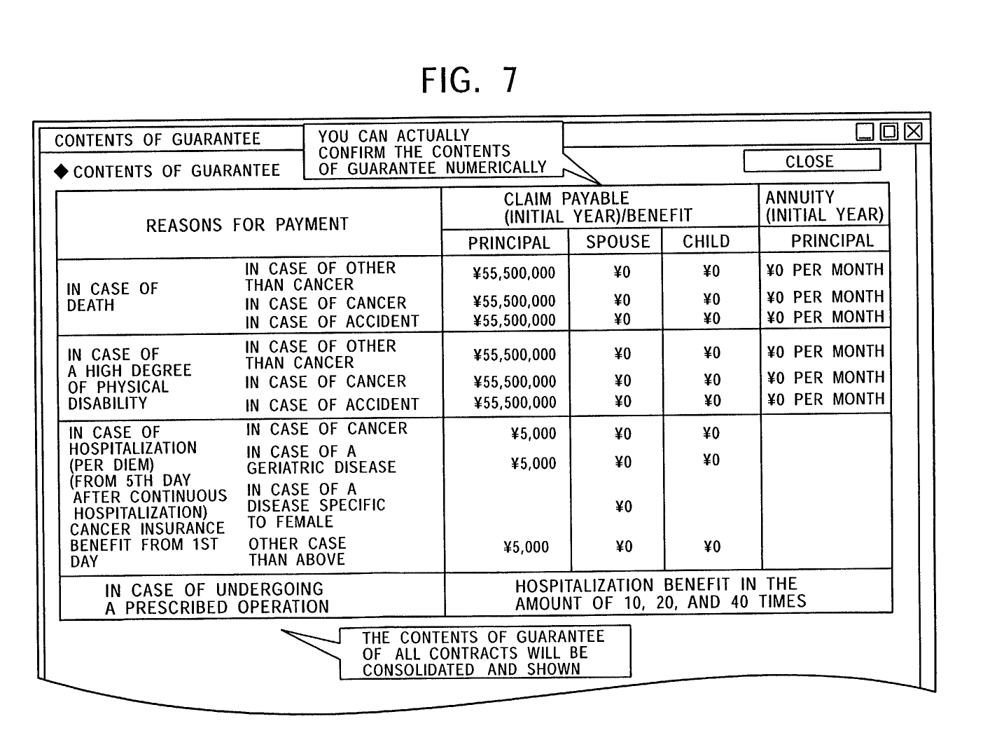

For instance, when the user selects the [CONTRACT CONTENTS] button, the details of the contents of the contract appear in the format of a list as shown in FIG. 5. Also, when the [GUARANTEE GRAPH] button is selected, the graph drawing module 18 is downloaded from the web server 10 and activated, whereby, for example, a graph shown in FIG. 6 is displayed. FIG. 6 shows a graph depicting the transition of the amount guaranteed at the top section, while a graph illustrating the yearly transition of the premium at the bottom section. In the case where the [GUARANTEE CONTENTS] button is selected, the details of the contents of the guarantee appear in the format of a list as shown in FIG. 7.

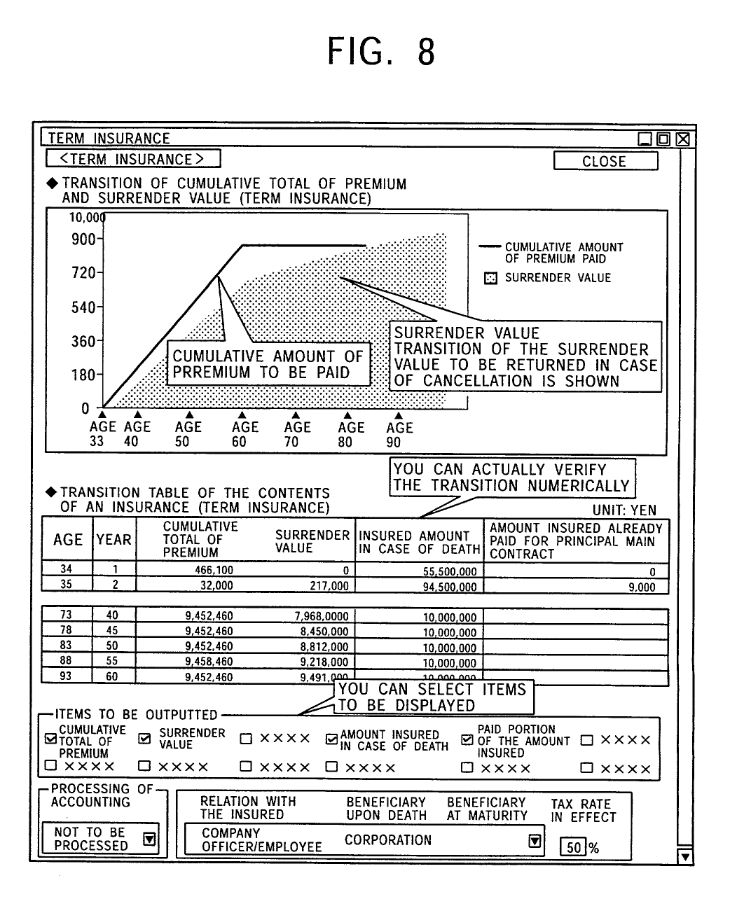

Further, when a [TERM INSURANCE] button is chosen to obtain information regarding the saving quality of life insurance, there appears a screen shown in FIG. 8, wherein the desired data come one display by marking necessary items at the bottom section of an item [ITEMS TO BE OUTPUTTED]. Assume that items [CUMULATIVE TOTAL OF PREMIUM] and [SURRENDER VALUE] are selected for the graph display items and that item [AMOUNT INSURED FOR DEATH] and [PAID PORTION OF THE AMOUNT INSURED] are selected for the table display items. In that case, the various cumulative calculation module 20 is downloaded from the web server 10 and activated, whereby the cumulative total of the premium to be paid, the amount insured for death, and the paid amount insured are respectively calculated.

Still further, the user client apparatus 40 turns in a request to the web server 10 to calculate the surrender value, and accordingly, the surrender value calculation module 16 of the web server 10 is activated, thereby calculating the surrender value which is notified to the user client apparatus 40. From the result of this calculation, the cumulative total of the paid premium and the surrender value are made by the graph drawing module 18 into a graph, resulting in a graph shown at the top section of FIG. 8. Moreover, these data and the data on the money insured for death and the paid portion of the money insured are numerically listed in a table as the middle section of FIG. 8 describes

At the bottom section of FIG. 8, there is shown information regarding the accounting processing in the case of an insurance contract with a corporation. In this particular example, an item [NOT TO BE PROCESSED] is selected. Suppose an item [TO BE PROCESSED] is entered. Then the accounting processing module 19 is downloaded by the web server 10 to the user client apparatus 40 and activated, thereby displaying information about handling from the standpoint of taxation business concerning the contractual mode of the premium or the money insured.

As is clear from the foregoing description, a major advantage of this invention is that the user, while referring to outputs of various information in this manner, can change the set up values in the design input screen as necessary and design the life insurance to meet one's specific need. Furthermore, once the design is completed, the contents of the design are printed out or outputted as a PDF file, which can be used to perform subsequent processes including examination of the contract as well as actual conclusion of the contract.

When the thus completed design is to be outputted as the PDF file, the user client apparatus 40, for example, gives instructions to the PDF creation module 17 of the web server 10 to output the contents of the design as a PDF file and receives a generated PDF file transfer. In the case of obtaining a printout, the graph drawing module 18, the accounting processing module 19, the various cumulative calculation module 20 and any other necessary module are activated on the web server 10 end and, for example, the charts equivalent to those shown in FIG. 8 are outputted to generate the PDF file. Then, the PDF file is downloaded through the web server 10 to the user client apparatus 40 end, activating, for instance, tools such as the Adobe Acrobat Reader (Acrobat is the registered trademark of Adobe System of the U.S.) to present a preview display on the client's screen or obtain a direct printout.

As described above, an outstanding feature of the free design service system of life insurance 1 is the ease of designing the kind of life insurance that the user desires. For example, by accessing the web server 10 via the network 30 from the user client apparatus 40 such as a personal computer available at home, anyone can readily design life insurance by one's own operation. That is, without being reserved towards the salesperson or being carried away by the salesperson's presentation, any one can examine and review life insurance at one's own pace. As a consequence, it is possible for the user to purchase a life insurance service in a manner convincing to oneself.

Equally advantageous is the fact that the life insurance company benefits as well, inasmuch as the user designs one's life insurance without requiring any work on the part of the operator, deepening one's understanding thereof, and thus greatly facilitating efficient processing that leads to the final stage of concluding the contract.

Another advantage is the absence of any complex computer operation, because the operation of the life insurance design by the user is made up of very simple operating steps much in the same manner as the normal operation of the home page, so that anyone can operate without difficulty. Moreover, a further system advantage of processing efficiency and good operability is offered by the free design service system of life insurance 1 according to the preferred embodiment of this invention in that various processes necessary for the system such as processing to calculate premium, processing to check compliance with the handling regulations, processing to calculate the surrender value, and processing to calculate various cumulative totals, and these tasks are all divided to the web server 10 end and the user client apparatus 40 as necessary, depending on the complexity of each processing, and executed, wherefore, even if a large number of people should happen to access the web server 10 concurrently, high-speed processing can be accomplished.

While the preferred form of this invention has been described, various modifications can be introduced.

In the foregoing explanation, the free design service system of life insurance 1 according to the preferred embodiment of this invention is presented as a system for each customer in the process of reviewing whether to participate in life insurance to make direct use thereof, and accordingly, the processing flow and effects are described. Nonetheless, the users of this system are not confined to the customers alone. For example, this system may be used by the salespersons of insurance companies as the sales support system.

In that case, the salesperson operates a personal computer, i.e., the user client apparatus 40, in front of a customer to whom insurance products are introduced, accessing the web server 10 via the network 30 and executing each processing described above. Namely, inputting each of the conditions posed by the customer, immediately designing insurance based thereon, and presenting information such as the contents of the designed contract and the contents of the guarantee to the customer, whereupon, while confirming the output screen with the customer, the salesperson provides further explanation of the contents with commentaries. In this manner, use of the free design service system of life insurance 1 according to the preferred embodiment of this invention enables the salesperson to design and present the insurance based on the specific conditions posed by the customer without delay in front of the customer.

It should be appreciated that as compared to the existing case where insurance is verbally explained or by presenting only a model case close to the customer's conditions, explanation of insurance can be provided in a manner more tangible and much easier to understand.

As mentioned above, one of the merits of the system according to this invention is that software having special function is not required whatsoever for the terminal equipment each salesperson uses, so long as the terminal equipment has functions of accessing the web server 10 and reading web pages, inasmuch as all processes associated with this system are executed by using functions offered on the browser by means of accessing the server from the terminal equipment via the Internet, hence, for example, in case of a version up of the software and data update, there is no need for each terminal equipment assigned to each salesperson to cope with but simply to change the software and data on the server, thus significantly facilitating software or data maintenance as compared to the conventional case of each salesperson utilizing exclusive hardware, and also making it possible for each salesperson to use the newest version environment.

There is an additional gain rendered by the use of this system particularly when a general-purpose personal computer with connectivity to the network is available at a location, where explanation is provided, in that a personal computer may be used to operate the free design service system of life insurance 1. Consequently, in some cases, the salesperson does not need to carry with oneself terminal equipment, thereby contributing to making sales activities more efficient. This is also effective in the case where explanation of insurance products is all of a sudden necessitated.

Diversity of applications is another improvement of this system, because of no need of exclusive software, say an agent handling products of a plurality of insurance companies and employing the similar systems of a plurality of insurance companies, thereby forestalling any system failure due to competing software, so that the system according to this invention can be used more easily.

Also, the design service system 1 according to this invention is applicable to not only life insurance but also any design service of insurance having similar characteristics. For instance, non-life insurance such as fire insurance for manufacturers, corporations, and other enterprises requires the settings of conditions as complex as those of life insurance explained in the preferred embodiment of this invention, wherefore implementation of the design service herein described is effective enough to be recommended for application thereto.

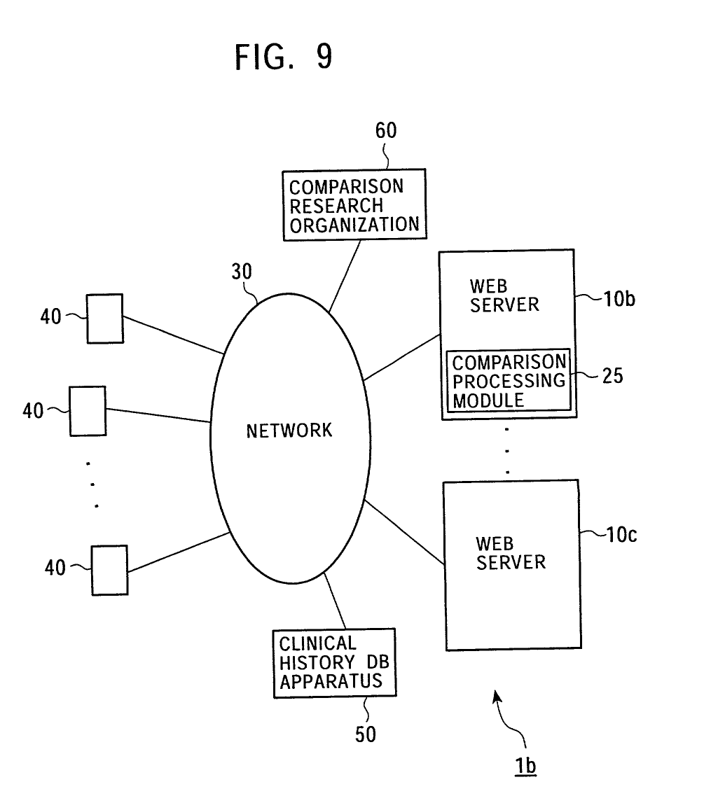

It should be mentioned that the setting items associated with the design of life insurance, output items subject to reference, items relating to graphic-making and other items are not limited to the preferred embodiment of this invention but can be made up in any manner. For example, the calculation of the premium as well as detection of the advisability of accepting an application of the prospective person to be insured may be arranged by referring to the clinical history thereof and other related records and using these data as the basis for determination. At that time, a system may be so designed as to enable the data on the clinical history to be inputted from the design input screen. Or as illustrated in FIG. 9, there may be another arrangement wherein relevant information can be incorporated by automatically referring to a clinical history database apparatus 50 of some kind.

There are indeed many options available in the free design service system of life insurance 1 according to the preferred embodiment of this invention. The clinical history database apparatus 50 may be a useful device offered by a hospital. Or the apparatus may be the kind of device owned by the insurance company and kept confidential even to the policyholders. In that case, it is not necessary to inform the user of the contents of the clinical history database apparatus 50, which needs to be made known merely as reference data in designing life insurance, thereby contributing to establishing the reputation that any information obtained from the system of this invention is all the more reliable in that it is subject to very few changes in the contract stage.

As regards the designed insurance, the system may be adapted to output the comparative results with the insurance products of other insurance companies: as shown in FIG. 9, in a web server 10b, there may be set up a comparative processing module 25 for comparing the contents of the life insurance designed to the information provided by a Web server 10c of other insurance companies; or a comparison research organization 60 may be set up as a third party organization separate and distinct from the web server 10b and the web server 10c.

In the free design service system of life insurance 1 according to the preferred embodiment of this invention, the user is supposed to design the life insurance and carries out processing up to and including the stage of obtaining various information regarding the insurance, any processing step thereafter leading to contracting being outside the scope thereof. This procedure notwithstanding, the system may be one that incorporates the succeeding steps all the way to establishing the life insurance contract based on the designed information and obtained data.

It should be mentioned that the “salesperson” employed in the preferred embodiment described above is not limited to the regularly employed staff of the insurance company. A wide range of persons involved in solicitation, sales, and promotion of insurance products, e.g., sales persons of agents handling the products of a plurality of insurance companies, are included with no restrictions imposed on the nomenclature, position, handling from the legal standpoint, and employment relationship.

Insofar as the screen output mode, graphic format, detailed structures of the web server 10 and the user client apparatus 40 are concerned, any optional form of construction is acceptable. In the preferred embodiment of this invention, the network 30 to which the web serve 10 and the user client apparatus 40 are connected is not confined to the Internet but any network is adequate.

As is clear from the foregoing description, according to this invention, it is possible to present the insurance design service providing system, apparatus, and method which make it possible for anyone to gain a variety of information regarding insurance, say life insurance, meeting the particular requirements of each individual. To be more specific, in the case where general user makes use thereof, there is no need of meeting directly with the salesperson and one can obtain easily the kind of information that concerns the insurance of each individual, at any time, with simple processing; in the case where the salesperson makes use thereof, it is possible to furnish one with a system of providing the insurance design service, apparatus, and method which enables one to acquire the insurance information matching the requirements of each customer at any time at any place by using no special hardware in a manner marked by the ease of maintenance.

It is further understood by those active in the field that various changes and modifications may be made within the scope of the present inventive concepts which are delineated by the following claims.

What is claimed is:

1. An insurance design service providing system comprising:
an arbitrary communication network;
a plurality of nodes connected to said communication network; and
a server device for generating information regarding an insurance product meeting conditions when prescribed conditions regarding the design of prescribed insurance are inputted from any of said nodes, and for transmitting thus generated information to said node from which said prescribed information is inputted.

2. The insurance design service providing system according to claim 1, wherein
said server device transmits a processing module for executing processing to generate said information to said node device.

3. The insurance design service providing system according to claim 2, wherein
said server device performs, with respect to the insurance product based on said inputted conditions, one, a plurality of, or all of the processes of examining whether said insurance product meets the prescribed regulations, calculating a premium, extracting the contents of a guarantee, calculating a surrender value, and detecting information regarding accounting processing, and making a comparison to other insurance products.

4. The insurance design service providing system according to claim 2, wherein
said server device transmits a graph drawing module to said node device for graphically displaying information on the result of said each process at said node device.

5. The insurance design service providing system according to claim 2, wherein said insurance is life insurance.

6. The insurance design service providing system according to claim 5, wherein
any of said plurality of nodes inputs the prescribed conditions relating to the design of life insurance into said server device.

7. The insurance design service providing system according to claim 6, wherein said server device generates information regarding the life insurance product meeting said inputted conditions.

8. The insurance design service providing system according claim 7, wherein
said prescribed conditions relating to the design of said life insurance comprises the conditions including one, a plurality of, or all of the conditions pertaining to age of a policyholder, gender thereof, a family composition thereof, a clinical history thereof, classification of insurance, type of insurance, a payment method of a premium, a term insured, a period of payment of the premium, and contents of a guarantee including an amount insured.

9. The insurance design service providing apparatus including a server device connected to an arbitrary network to which a plurality of nodes is connected, wherein said server device comprising:
a receiving means for receiving prescribed conditions relating to design of prescribed insurance from any said node;
an information generation means for generating information regarding said insurance product meeting said received conditions; and
a transmission means for transmitting said generated information to said node from which said prescribed information is inputted.

10. The insurance design service providing apparatus according to claim 9, wherein
said transmission means transmits a processing module for generating insurance specification information based on the information generated by said information generation means to said node to which said prescribed information is inputted.

11. The insurance design service providing apparatus according to claim 10, wherein
said node generates said insurance specification information on the node.

12. The insurance design service providing apparatus according to claim 11, wherein
said information generation means performs, with respect to the insurance product, based on said inputted conditions, one, a plurality of, or all of the processes of examining whether said insurance product meets the prescribed regulations, calculating the premium, extracting the contents of the guarantee, calculating the surrender value, and detecting information regarding accounting processing, and making the comparison to other insurance products.

13. The insurance design service providing apparatus according to claim 12, wherein
said information generation means generates information on the results of said processes.

14. The insurance design service providing apparatus according to claim 13, wherein
said transmission means transmits the graph drawing module to said node for displaying information on the result of said each process.

15. The insurance design service providing apparatus according to claim 14, wherein
said transmission means causes to graphically display information about the result of said each process on the node.

16. The insurance design service providing apparatus according to claim 11, further including:
a database means for storing the prescribed conditions relating to the design of the prescribed insurance inputted from said node.

17. The insurance design service providing apparatus according to claim 16, wherein
said insurance is life insurance.

18. The insurance design service providing apparatus according to claim 17, wherein
said receiving means receives the prescribed conditions relating to the design of life insurance from said node.

19. The insurance design service providing apparatus according to claim 18, wherein
said information generation means generates information regarding the life insurance product meeting said received conditions.

20. The insurance design service providing apparatus according to claim 19, wherein
said prescribed conditions relating to the design of said life insurance comprise the conditions including one, a plurality of, or all of the conditions pertaining to the age of the policyholder, the gender thereof, the family composition thereof, the clinical history thereof, the classification of insurance, the type of insurance, the payment method of the premium, the term insured, the period of payment of the premium, and the contents of the guarantee including the amount insured.

21. An insurance design service providing method comprising the steps of:
connecting a server device to a communication network as a web site, wherein a plurality of nodes is connected to said communication network and said server device generates information regarding the insurance product meeting said conditions on the basis of the prescribed conditions relating to the design of the prescribed insurance to be inputted;
transmitting an input processing module for inputting said conditions to said node when said web site is accessed from any of said nodes;
generating desired information regarding the life insurance product meeting said conditions when said conditions are inputted via said input processing module; and
outputting said generated information from the node to which said conditions are inputted.

22. The insurance design service providing method according to claim 21, wherein,
said server device transmits the prescribed processing module relating to the design of said insurance to said node, when said web site is accessed from any of said nodes;
said server device generates specified information regarding the life insurance product meeting said inputted conditions; and
said node generates insurance specification information by executing said processing module based on said transmitted information.

23. The insurance design service providing method according to claim 22, wherein
said insurance is life insurance; and
the desired information relating to the insurance product meeting said conditions comprises information including one, a plurality of, or all of the information about whether said insurance product meets the prescribed regulations, information about the premium, information about the contents of the guarantee, information about the surrender value, and information about the accounting processing, and information about the result of comparing at least any one of said items to other life insurance products.

24. The insurance design service providing method according to claim 22, wherein
said insurance is life insurance; and
said prescribed conditions relating to the design of said life insurance comprise the conditions including one, a plurality of, or all of the conditions pertaining to the age of the policyholder, the gender thereof, the family composition thereof, the clinical history thereof, the classification of insurance, the type of insurance, the payment method of the premium, the term insured, the period of payment of the premium, and the contents of the guarantee including the amount insured.
